(19) United States
(12) Patent Application Publication
(10) Pub. No.: US 2021/0092107 A1
(43) Pub. Date: Mar. 25, 2021

(54) SECURE OFF-PREMISES ACCESS OF PROCESS CONTROL DATA BY A MOBILE DEVICE

(71) Applicant: FISHER-ROSEMOUNT SYSTEMS, INC., Round Rock, TX (US)

(72) Inventors: Federico Jose Guerrero Aragon, Paranaque (PH); Richard Clarence Fabros, Mandaluyong City (PH); Erwin Paguio, Mandaluyong City (PH); George Siton, Bacoor city (PH); Cristopher Ian Sarmiento Uy, Metro Manila (PH)

(21) Appl. No.: 17/022,425

(22) Filed: Sep. 16, 2020

Related U.S. Application Data
(60) Provisional application No. 62/904,352, filed on Sep. 23, 2019.

(51) Int. Cl. H04L 29/06; H04L 12/66

(52) U.S. Cl. CPC H04L 63/083; H04L 67/40; H04L 12/66; H04L 63/061; H04L 63/062

(57) ABSTRACT

A system and method for facilitating secure communication between a process control application executing on a mobile device and a mobile server communicatively coupled to a process control environment includes the instantiation, in a cloud-based environment, of a relay connection element. Each of the mobile server and any mobile applications executing on mobile devices authenticates itself to the relay connection element. The relay connection element, the process control applications executing on the mobile devices, and the mobile server, each receive the necessary credentials through a series of authenticated requests between a variety of elements in the cloud-based environment, such that elements in the system necessarily authenticate one another before any information is provided to another element.

### FIELD OF THE DISCLOSURE

The present disclosure generally relates to mobile monitoring of process control environments and, in particular, to a system and method for securely authenticating mobile devices outside of the process plant environment to provide customizable, real-time awareness of process control systems on mobile devices.

### BACKGROUND

Distributed control systems (DCS) are used in a variety of process industries including chemical, petrochemical, refining, pharmaceutical, food and beverage, power, cement, water and wastewater, oil and gas, pulp and paper, and steel, and are used to control batch, fed-batch, and continuous processes operating at a single site or at remote locations. Process plants typically include one or more process controllers communicatively coupled to one or more field devices via analog, digital or combined analog/digital buses, or via a wireless communication link or network. Collectively, the various devices perform monitoring, control, and data collection functions to control the process, safety shutdown systems, fire and gas detection systems, machine health monitoring systems, maintenance systems, decision support, and other systems.

The field devices, which may be, for example, valves, valve positioners, switches and transmitters (e.g., temperature, pressure, level and flow rate sensors), are located within the process environment and generally perform physical or process control functions such as opening or closing valves, measuring process parameters, etc. to control one or more process executing within the process plant or system. Smart field devices, such as the field devices conforming to the well-known Fieldbus protocol may also perform control calculations, alarming functions, and other control functions commonly implemented within the controller. The process controllers, which are also typically located within the plant environment, receive signals indicative of process measurements made by the field devices and/or other information pertaining to the field devices and execute a controller application that runs, for example, different control modules which make process control decisions, generate control signals based on the received information and coordinate with the control modules or blocks being performed in the field devices, such as HART®, WirelessHART®, and FOUNDATION® Fieldbus field devices. The control modules in the controller send the control signals over the communication lines or links to the field devices to thereby control the operation of at least a portion of the process plant or system.

Information from the field devices and the controller is usually made available over a data highway to one or more other hardware devices, such as operator workstations, personal computers or computing devices, data historians, report generators, centralized databases, or other centralized administrative computing devices that are typically placed in control rooms or other locations away from the harsher plant environment. Each of these hardware devices typically is centralized across the process plant or across a portion of the process plant. These hardware devices run applications that may, for example, enable an operator to perform functions with respect to controlling a process and/or operating the process plant, such as changing settings of the process control routine, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc. The data highway utilized by the hardware devices, controllers and field devices may include a wired communication path, a wireless communication path, or a combination of wired and wireless communication paths.

As an example, the DeltaV™ control system, sold by Emerson Process Management, includes multiple applications stored within and executed by different devices located at diverse places within a process plant. A configuration application, which resides in one or more workstations or computing devices, enables users to create or change process control modules and download these process control modules via a data highway to dedicated distributed controllers. Typically, these control modules are made up of communicatively interconnected function blocks, which are objects in an object oriented programming protocol that perform functions within the control scheme based on inputs thereto and that provide outputs to other function blocks within the control scheme. The configuration application may also allow a configuration engineer to create or change operator interfaces which are used by a viewing application to display data to an operator and to enable the operator to change settings, such as set points, within the process control routines. Each dedicated controller and, in some cases, one or more field devices, stores and executes a respective controller application that runs the control modules assigned and downloaded thereto to implement actual process control functionality. The viewing applications, which may be executed on one or more operator workstations (or on one or more remote computing devices in communicative connection with the operator workstations and the data highway), receive data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application.

In many distributed process control systems, each field device in the process plant is assigned a unique device tag. The unique device tag provides an easy way to reference the corresponding field device. Device tags may be used during the configuration of the process control system to specify the source or destination, respectively, of an input or output to a function block in a control module. Each signal type has associated with it a particular format or set of information, and the device tag for a particular device may have associated with it a specific signal type such that when the device tag is associated with an input or output of a function block, the function block knows the format and information associated with the signal. In cases in which a field device has multiple signals associated with it (e.g., a valve may measure and transmit both pressure and temperature), device signal tags may be associated with each signal of the field device.

For a variety of reasons, access to data of the process control system has traditionally been available only while on the process plant premises and/or while using a device connected to the data highway that couples the operator workstations, controllers, data historians, and other equipment. Security is a particular concern with respect to process control systems and, as such, process control system operators generally physically separate the process control system from external network environments (e.g., the internet) to limit or prevent opportunities for outside actors to cause damage to the process control system, affect product quality or viability, or access or steal proprietary information.

More recently, mobile solutions have emerged that allow users to view information from the process control system via mobile devices such as smart phones, even when not coupled directly to the process networks and data highways that make up the process plant. One such mobile solution is the DeltaV™ Mobile application from Emerson Process Management. While such solutions may allow a user to access a variety of data from the process plant in real time both inside and outside of the process plant, in practice access to such data from outside the process plant is severely limited and/or has been limited to unidirectional communication of information from the process plant to the mobile device(s) in order to prevent injection of malicious attacks and/or commands into the process control environment, at least because adequate authentication processes in the complex context of a process control environment have not been achieved. That is, previous systems required a mobile server receiving requests at a publicly available application layer endpoint, which is undesirable for the security-related reasons described above.

### SUMMARY OF THE DISCLOSURE

In embodiments, a cloud-based authentication method includes instantiating in a cloud-based server a relay element configured to transfer data between a process control application executing on a mobile device and a mobile server communicatively coupled to a process control environment. The relay element is communicatively coupled, via the Internet, for example, to the mobile device and to the mobile server. The method authentication method includes receiving at the relay element, from the process control application executing on the mobile device, a first validation key, and comparing, in the relay element, the first validation key to an application validation key. If the first validation key matches the application validation key, the relay element validates the process control application and, if the first validation key does not match the application validation key, access to the relay element by the process control application is denied. The method also includes receiving at the relay element from the mobile server a second validation key, and authenticating the mobile server at the relay element if the second validation key is valid. Thereafter, the method includes allowing communication, via the relay element, between the process control application executing on the mobile device and the mobile server if both the process control application and the mobile server are validated.

In other embodiments, a method of providing process control data to a process control application operating on a mobile device includes sending, from a mobile server communicatively coupled to a process control environment, to an application web services API operating on a cloud-based server, a command to instantiate in the cloud-based server a relay element configured to transfer data between the process control application and the mobile server. The method includes sending to the relay element, via a relay gateway service, a validation key operable to authenticate the mobile server to the relay element, and receiving from the process control application, via the relay element and the relay gateway service, a username and a password associated with a user of the process control application. The method further includes authenticating the user of the process control application, and sending to the process control application, via the relay element and the relay gateway service, a list of available process control data. Thereafter, the method includes receiveing from the process control application, via the relay element and the relay gateway service, a selection of process control data to transmit; and transmitting to the process control application, via the relay element and the relay gateway service, the selected process control data.

In embodiments, a system for providing to a process control application secure off-premises access to a process control environment includes a mobile server communicatively coupled to a process control environment and configured to (i) receive from the process control environment real-time process control data, and (ii) send control commands to a controller in the process control environment. The system also includes a cloud-based server environment, communicatively coupled to the mobile server, via a relay gateway service. The cloud-based server environment, in turn, includes a cloud-based relay element configured to transfer data between the process control application executing on a mobile device and the mobile server. A first application programming interface (API) of the cloud-based server environment is configured to receive from the mobile server a request to instantiate and enable the cloud-based relay element. A second API of the cloud-based server environment is configured to receive from the process control application a request to access the cloud-based relay element, to authenticate a user of the process control application, and to provide to the process control application a first validation key for accessing the cloud-based relay element. A relay management database of the cloud-based server environment is storing configuration information for the cloud-based relay element. A key vault element of the cloud-based server environment is storing authentication keys. The system includes a first network coupling the mobile server to the process control environment, a second network coupling the mobile server to the cloud-based server environment, and a third network coupling the process control application to the cloud-based server environment.

### BRIEF DESCRIPTION OF THE DRAWINGS

The features and advantages of the methods, apparatus, and systems described herein will be best appreciated upon reference to the following detailed description and the accompanying drawings, in which:

FIG. 1 is a block diagram of an example process control environment according to the present description;

FIG. 2 depicts a block diagram illustrating an overall architecture of the system for mobile information distribution in a process control environment in accordance with the present description;

FIG. 3 is a block diagram depicting various components involved in the secure authentication system and methods and flows of information between the components;

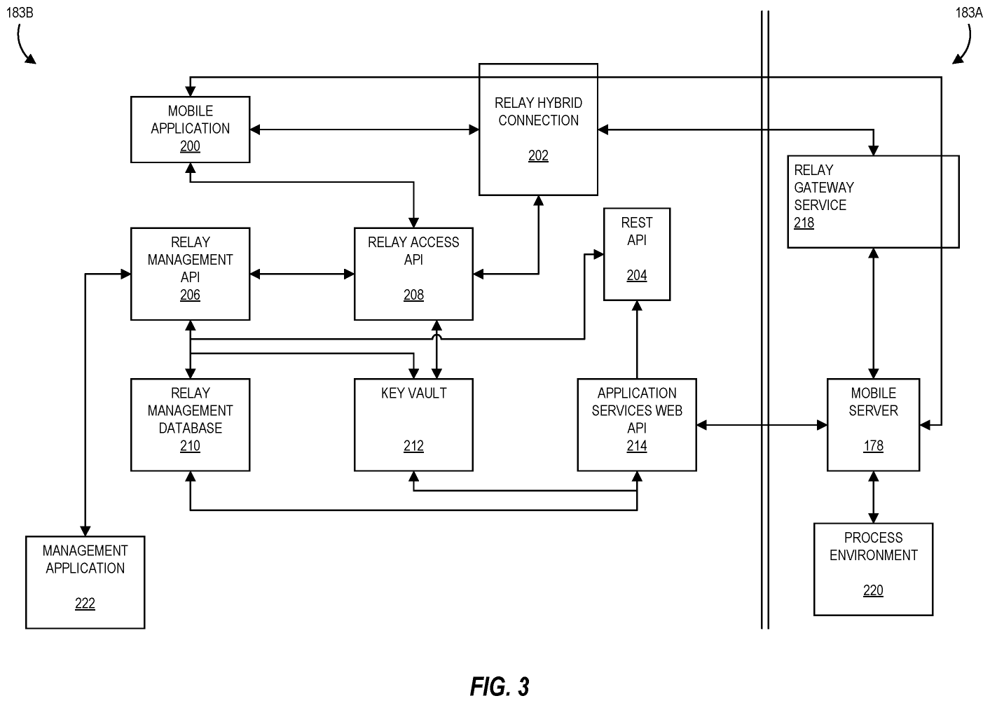

FIG. 4 is a communication flow diagram depicting a method for allowing a mobile server to create, enable, disable, or otherwise modify a relay element;

FIG. 5 is a communication flow diagram depicting a method of authenticating a mobile server to a relay element;

FIG. 6 is a communication flow diagram depicting a method of authenticating a mobile application to the relay element; and

FIG. 7 is a communication flow diagram depicting a sub-method of the method of FIG. 6 for authenticating a mobile server to a relay element.

### DETAILED DESCRIPTION

As described above, known distributed process control systems lack the ability for operators, maintenance personnel, and others associated with a process control system to securely maintain situational awareness when away from operator workstations and/or away from the physical location of the process plant. As a result, plant personnel are unable to observe the operation of the process control system and process plant unless they are physically present, or are unable to securely send control commands to the process control system when not on process plant premises because of a lack of robust authentication protocols. Because process plants typically operate with multiple shifts, the observation and operation of the process plant is often handed off multiple times each day. While plant personnel on a particular shift may leave notes for those people on the following shifts, these shift changes result in discontinuities in the operation and management of the processes and equipment, which can have deleterious effects on product quality, plant efficiency, maintenance, environmental safety, regulatory compliance, and other aspects of process plant management. Implementations of the systems, devices, and methods for secure authentication of mobile devices described herein can facilitate secure access to information, as well as secure transmission of control commands, acknowledgement of alarms or events, and other mobile-to-process communications, the advantages of which will become apparent throughout the following disclosure.

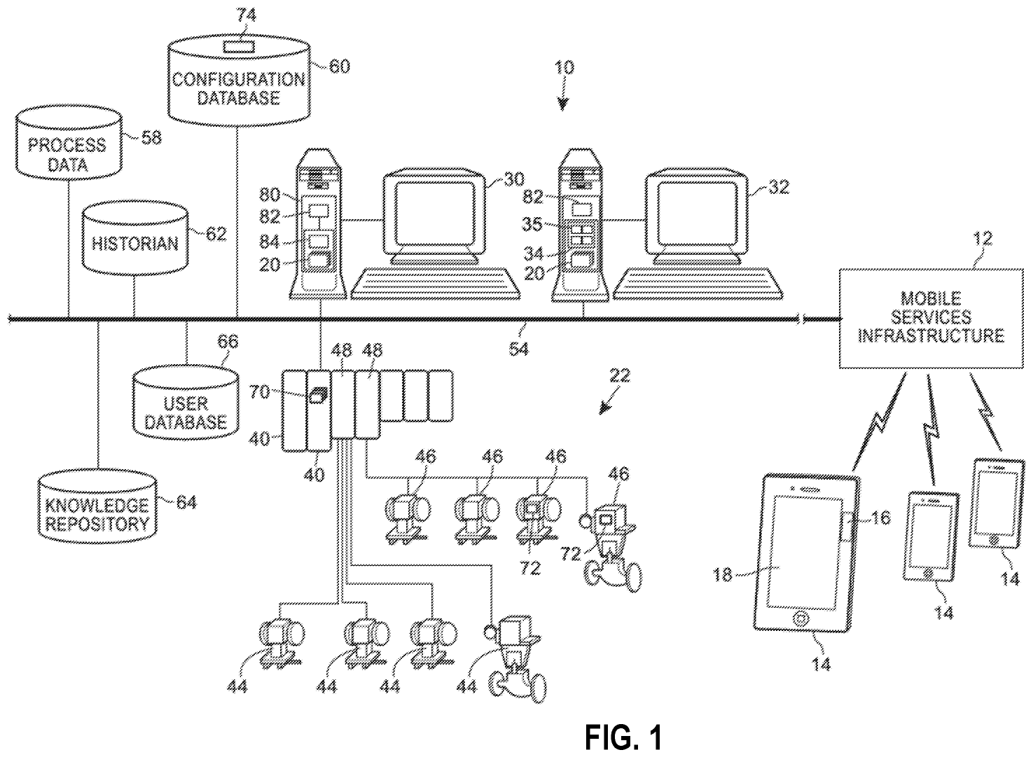

FIG. 1 illustrates an example process plant network 10 including mobile services infrastructure 12 for supporting a plurality of mobile devices 14, not necessarily located on the process plant premises, having access to data associated with the process plant. As will be described in detail herein, the mobile services infrastructure 12 facilitates real-time, secure unidirectional or bidirectional communication between the mobile devices 14 and the process plant network 10, including communication of any of the process plant data available within the process control plant network 10, and of commands and other data from the mobile devices 14 to the process control plant network 10, while maintaining the security of the process plant network 10. Each of the mobile devices 14 includes, among other elements, an application 16 executable by the mobile device 14 to allow a user to interact with the process plant data via a graphical user interface (GUI) 18. As will be described below, the mobile services infrastructure 12 includes an architecture for secure authentication of the mobile devices.

In general, plant personnel utilize one or more applications 20 to supervise or control the operation of the process plant 10 and a distributed control system 22 implemented within the process plant 10. The viewing or monitoring applications 20 generally include a user interface application that uses various different displays to graphically depict process graphics to each of the operator and the maintenance technician and/or other users at workstations, such as workstations 30 and 32.

The process plant environment of FIG. 1 also includes a graphical configuration system 34. The graphical configuration system 34 generally facilitates the creation of control and monitoring schemes, including graphical displays, for control of the process plant. The graphical configuration system 34 may include, for example, a configuration editor 35 that can be used to control modules and control module templates, graphical displays and templates, and other aspects of the control system, that are stored in a library, and that can be subsequently used to create instances or usages that are actually executed in the control of the process plant by downloading instances of the control modules to a controller, or by executing instances of the graphical displays in user displays presented to, for example, the operator and maintenance person, during operation of the plant 10. Of course, each of the graphics configuration system 34, the configuration editor 35, and the various control modules, templates, and graphical displays may be stored in a tangible computer readable memory or medium and execute on one or more processors to perform the functions described herein.

As is typical, the distributed process control system 22 illustrated in FIG. 1 has one or more controllers 40, each of which is connected to one or more field devices 44 and 46 (which may be smart devices) via input/output (I/O) devices or cards 48 which may be, for example, Fieldbus interfaces, Prof ibus interfaces, HART interfaces, standard 4-20 ma interfaces, etc. The controllers 40 are also coupled to the one or more host or operator workstations 30-32 via a data highway 54 which may be, for example, an Ethernet link. A process data database 58 may be connected to the data highway 54 and operates to collect and store process variable, process parameter, status and other data associated with the controllers, field devices and any other devices within the plant 10. During operation of the process plant 10, the process data database 58 may receive process data from the controllers 40 and, indirectly, the field devices 44-46 via the data highway 54.

A configuration database 60 stores the current configuration of the distributed control system 22 within the plant 10 as downloaded to and stored within the controllers 40 and field devices 44, 46. The configuration database 60 stores process control functions defining the one or several control strategies of the distributed control system 22, configuration parameters of the devices 44, 46, the assignment of the devices 44, 46 to the process control functions, and other configuration data related to the process plant 10. The configuration database 60 may additionally store graphical objects or user displays as well as configuration data associated with these objects or displays as described in more detail herein to provide various graphical representations of elements within the process plant 10. Some of the stored graphical objects may correspond to process control functions (e.g., a process graphic developed for a certain PID loop), and other graphical objects may be device-specific (e.g., a graphic corresponding to a pressure sensor).

A data historian 62 (another database) stores events, alarms, comments and courses of action taken by operators. The events, alarms, and comments may pertain to individual devices (e.g., valves, transmitters), communication links (e.g., wired Fieldbus segments, WirelessHART communication links), or process control functions (e.g., a PI control loop for maintaining a desired temperature set point). Further, a knowledge repository 64 stores references, operator logbook entries, help topics, or links to these and other documentation that operators and maintenance technicians may find useful when supervising the process plant 10. Still further, a user database 66 stores information about users such as the operator and the maintenance technician. For each user, the user database 66 may store, for example, his or her organizational role, the user's span of control, an area within the process plant 10 with which the user is associated, work team association, security information, system privileges, shift information, etc.

Each of the databases 58-66 may be any desired type of data storage or collection unit having any desired type of memory and any desired or known software, hardware or firmware for storing data. Of course, the databases 58-66 need not reside in separate physical devices. Thus, in some embodiments, some of the databases 58-66 may be implemented on a shared data processor and memory. In general, it is also possible to utilize more or fewer databases to store the data collectively stored and managed by the databases 58-66 in the example system of FIG. 1.

While the controllers 40, I/O cards 48 and field devices 44, 46 are typically located down within and distributed throughout the sometimes harsh plant environment, the operator workstations 30 and 32 and the databases 58-66 are usually located in control rooms or other less harsh environments easily assessable by controller, maintenance, and various other plant personnel. However, in some cases, handheld devices coupled to the data highway 54 may be used to implement these functions and these handheld devices are typically carried to various places in the plant. Such handheld devices, and in some cases, operator workstations and other display devices may be connected to the DCS 22 via wireless communication connections. The handheld devices are distinguished from the mobile devices 14 in that the mobile devices are not necessarily present on the process plant premises and need not be coupled directly (via wired or wireless means) to the data highway 54.

As is known, each of the controllers 40, which may be, by way of example, the DeltaV™ controller sold by Emerson Process Management, stores and executes a controller application that implements a control strategy using any number of different, independently executed, control modules or blocks 70. Each of the control modules 70 can be made up of what are commonly referred to as function blocks wherein each function block is a part or a subroutine of an overall control routine and operates in conjunction with other function blocks (via communications called links) to implement process control loops within the process plant 10. As is well known, function blocks, which may be objects in an object oriented programming protocol, typically perform one of an input function, such as that associated with a transmitter, a sensor or other process parameter measurement device, a control function, such as that associated with a control routine that performs PID, fuzzy logic, etc., control, or an output function that controls the operation of some device, such as a valve, to perform some physical function within the process plant 10. Of course hybrid and other types of complex function blocks exist, such as model predictive controllers (MPCs), optimizers, etc. While the Fieldbus protocol and the DeltaV system protocol use control modules and function blocks designed and implemented in an object oriented programming protocol, the control modules could be designed using any desired control programming scheme including, for example, sequential function block, ladder logic, etc., and are not limited to being designed and implemented using the function block or any other particular programming technique. Each of the controllers 40 may also support the AMS® suite of applications sold by Emerson Process Management and may use predictive intelligence to improve availability and performance of production assets including mechanical equipment, electrical systems, process equipment, instruments, non-smart and smart field devices 44, 46, etc.

As described, the DCS 22 includes one or more of the controllers 40 communicatively coupled to the workstation(s) 30, 32 in the control room. The controllers 40 automate control of the field devices 44, 46 in the process area by executing process control strategies implemented via the workstations 30, 32. An example process strategy involves measuring a pressure using a pressure sensor field device and automatically sending a command to a valve positioner to open or close a flow valve based on the pressure measurement. The I/O cards 48 translate information received from the field devices 44, 46 to a format compatible with the controllers 40 and translate information from the controllers 40 to a format compatible with the field devices 44, 46.

Through the I/O cards 48, the controller 40 may communicate with the field devices 44, 46 according to the control modules 70 that have been downloaded to the controller 40. The control modules 70 are programmed using the configuration system 34. In the configuration system 34, an engineer may create the control modules 70 by, for instance, instantiating one or more function blocks. By way of example, the configuration engineer may instantiate an AI function block to receive an analog input from one of the field devices 44, 46, which AI function block may receive a variety of values (e.g., a signal value, alarm hi and low limits, a signal status, etc.) associated with the analog output of the field device 44, 46. The AI function block may output a corresponding signal to another function block (e.g., a proportional-integral-derivative (PID) control function block, a custom function block, a display module, etc.) Once the AI function block is instantiated, associating the function block with a unique device tag associated with the field device 44, 46 will cause the function block, once downloaded to the controller 40, to cooperate with the appropriate I/O card 48 to process information from the correct field device 44, 46.

In the plant network 10 illustrated in FIG. 1, the field devices 44, 46 connected to the controllers 40 may be standard 4-20 ma devices, may be smart field devices, such as HART®, Profibus, or FOUNDATION® Fieldbus field devices, which include a processor and a memory, or may be any other desired type of devices. Some of these devices, such as Fieldbus field devices (labeled with reference number 46 in FIG. 1), may store and execute modules, or sub-modules, such as function blocks, associated with the control strategy implemented in the controllers 40 or which perform other actions within the process plant, such as data collection, trending, alarming, calibration, etc. Function blocks 72, which are illustrated in FIG. 1 as being disposed in two different ones of the Fieldbus field devices 46, may be executed in conjunction with the execution of the control modules 70 within the controllers 40 to implement process control, as is well known. Of course, the field devices 44, 46 may be any types of devices, such as sensors, valves, transmitters, positioners, etc., and the I/O devices 48 may be any types of I/O devices conforming to any desired communication or controller protocol such as HART, Fieldbus, Profibus, etc.

With continued reference to FIG. 1, the workstations 30 and 32 may include various applications that are used for various different functions performed by the personnel within the plant 10. Each of the workstations 30 and 32 includes a memory 80 that stores various applications, programs, data structures, etc., and a processor 82 which may be used to execute any of the applications stored in the memory 80. In the example illustrated in FIG. 1, the workstation 30 also includes, in addition to the display and viewing application 20, one or more process controller configuration applications 84 which may include, for example, control module creation applications, operator interface applications and other data structures which can be accessed by any authorized configuration engineer to create and download control routines or modules, such as the control modules 70 and 72, to the various controllers 40 and devices 46 of the plant 10. The configuration applications 84 also include the display or graphical configuration system 34 having the configuration editor 35, which may be used to create the control modules 70.

Broadly speaking, the viewing application 20 allows operators to view display modules configured to provide specific information about the operation of specific areas of the process plant 10, and to control the operation of the process plant 10 according to the information on the display modules. The display modules are rendered on the workstations 30, 32, and incorporate real-time process data received from the controllers 40 and the field devices 44, 46. As used herein, “real-time” communication of data refers to electronic communication of data through electronic communication networks with ordinary delays for processing, routing, and transmission, without the intentional introduction of additional non-trivial delays. In some embodiments, trivial delays of less than five seconds (and preferably less than two seconds) may be introduced to reduce network congestion when communicating data in real-time. The display modules may be any type of interface that, for example, enables an operator or other use to manipulate data values (e.g., perform reads or writes) to monitor or alter operation of the field devices 44, 46, the control modules 70 and function blocks 72, and the DCS 22 and process plant 10 as a whole. The display modules may be stored in the memory 80 of the workstations 30, 32, and may also be stored in the configuration database 60.

The control modules 70 and, in some embodiments, the display modules may be part of a configuration file 74 in the configuration database 60. That is, the control modules 70 may be stored in the configuration file 74 together with the display modules or separately from the display modules. In any event, the configuration file 74 generally stores the entire configuration of the DCS 22, including devices, device tags, friendly names, data formatting information (e.g., scaling information, unit types, etc.) which variables are associated with each control loop, the control strategies defined, etc. As indicated previously, the configuration file 74 may also be downloaded to the controllers 40 to implement the control strategies defined in the configuration file 74.

As will be appreciated, the process plant 10 may include many hundreds, thousands, or even tens of thousands of signals, output from transmitters (i.e., sensors) on hundreds or thousands of field devices 44, 46, and/or input to those field devices 44, 46 to cause the field devices 44, 46 to perform control functions according to the control strategies programmed into the control modules 70. The plant 10 may be divided into different areas, multiples of which areas may be controlled by a single controller 40, each of which areas may be controlled by a single controller or multiple controllers 40, or some combination. In any event, the field devices 44, 46 that make up the process plant 10 are likely to be duplicated individually many times over in the process plant 10 (e.g., there may be many of any type of valve, many pumps, many heaters, many tanks, etc.). The field devices 44, 46 may also be combined into functional groups within a physical area (“process areas”), in which the field devices 44, 46 in that process area perform a specific portion of the overall process. For instance, a particular process area may have the equipment for generating steam for other parts of the process. Within the process areas, there may be duplicated pieces or groups of equipment (“process units”) that share a similar construction and function. As an example, a process unit in the steam generation process area may include a boiler and a turbo generator, and the process area may include multiple instances of this process unit.

### System Architecture

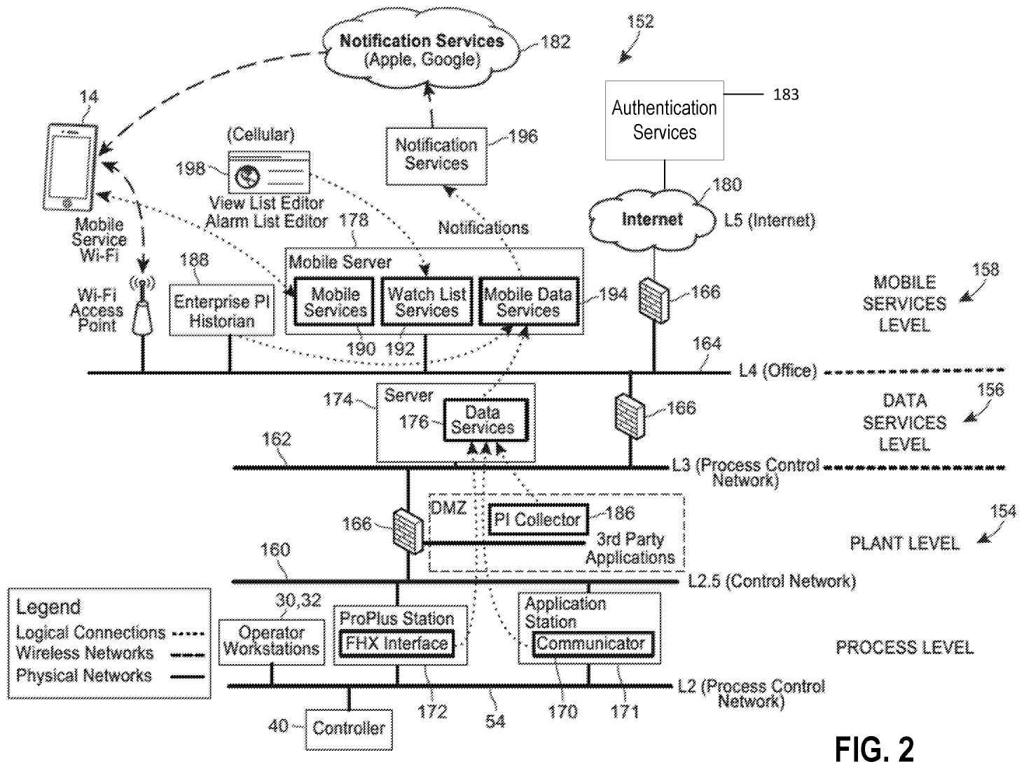

Turning now to FIG. 2, a block diagram illustrates an overall architecture 152 of the system for mobile information distribution in a process control environment that includes authentication services architecture for authenticating the mobile devices 14, as well as other components of the overall architecture 152, as described herein. The architecture 152 is described for the purpose of contextualizing the authentication services architecture described herein. The architecture 152 is generally divided into three levels: a plant/process level 154, a data services level 156, and a mobile services level 158 that, collectively, include four to six different networks. The plant/process level 154 includes the field network (not shown in FIG. 2) coupling the controllers 40 to the field devices 44, 46, and the control network (depicted in FIG. 1 as the data highway 54) coupling the controllers 40 to the workstations 30, 32, the databases 58-66, and other components that are within the process control plant 10. The plant/process level 154 may optionally include an intermediary network 160 that may couple the control network 54 to other business level applications. The plant/process level 154 is coupled to the data services level 156 by network 162. The data services level 156 is coupled to the mobile services level 158 by a network 164. The mobile services level 158 includes one or more other networks, such as the Internet and/or mobile telephony/data networks. Each of the layers 154, 156, 158 and, in fact, each of the networks, may be isolated from the others by hardware and/or software firewalls , in addition to other security measures. The layered architecture allows isolation between the various networks 54, 160, 162, 164, etc.

At the plant/process level 154, a communicator interface 170 provides the interface between the controllers 40 and the process plant 10 on one side, and the data services level 156 on the other side. While a single communicator interface 170 is depicted in FIG. 1L as communicating with a single controller 40 (and accordingly, with a single process plant 10), the communicator interface 170 may communicate with a multiplicity of controllers 40 controlling a single process plant, where various areas of the process plant 10 are controlled by separate controllers 40. It is also contemplated that, in embodiments, multiple process control systems 10 may be coupled to the data services level 156 and to the mobile services level 158 by multiple communicator interfaces 170. In a specific embodiment, a communicator interface 170 is coupled to each process control system 10, and the group of communicator interfaces 170 is coupled to the data services level 156. It is also envisioned that the multiple control systems may be physically located at different sites (e.g., at different chemical plants).

The communicator interface 170 may be part of a larger portal 171 that provides the overall interface to the data services and mobile services levels 156 and 158, respectively. The portal 171 may include functionality such as facilitating configuration of user information, device and system information, and software/hardware licenses.

Also in the plant/process level 154, a file interface 172 functions to transport the configuration file 74 to the data services level 156. In some embodiments, the file interface 172 is part of a dedicated one of the workstations 30, 32 used to configure the process plant 10 and including the graphical configuration system 34, the configuration editor 35, etc. In other embodiments, the file interface 172 may be part of the communicator interface 170. In any event, the file interface 172 is coupled to the data services level 156 and transports configuration data of the process plant to the data services level 156.

At the data services level 156, a data server 174 includes a number of different data services 176 that, collectively, receive data from the communication interface 170 and the file interface 172, and communicate the received data to the mobile services level 158. Among the data received from the plant/process level 154 and communicated to the mobile services level 158 are: alarms, process parameters, diagnostics, historical data, and configuration data. The various data services 176 may also serve to index the configuration file 74 received from the file interface 172. The indexing operations may including indexing for specific information such as module parameters and module hierarchy in order to support detailed search capabilities, which may allow users to search for parameter names, device tags, alarms, or other data of the process plant 10.

A mobile server 178 is the heart of the mobile services level 158. The mobile server 178 supports connections to the mobile devices 14, supports configuration of the various lists to which the mobile devices 14 are subscribed (e.g., alarm lists, watch lists, etc.), provides search capabilities, and manages mobile notifications. The mobile server 178 is also responsible for creating and maintaining the subscriptions to various data from the data services 176. The mobile server 178 is coupled to the mobile devices 14 over any of a variety of wireless data technologies, which may include Wi-Fi (i.e., protocols of the IEEE 802.11 protocol suite) and/or mobile (“cellular”) infrastructure using any of the various data services available presently or in the future including, but not limited to, LTE services, some or all of which may make use of the internet 180.

The mobile services level 158 also includes an authentication services component 183 that will be described in greater detail below. The mobile services component 183 includes a sub-architecture that communicates with the mobile server 178 to perform a variety of authentication services, including authentication of applications executing on the mobile devices 14, the mobile server 178 and, in embodiments, other components as well.

The mobile devices 14 may include mobile devices running the Android mobile operating system developed by Google, mobile devices running the iOS or iPadOS mobile operating system developed by Apple, or any other operating system presently known or developed in the future. For mobile devices 14 running the Android, iOS, and/or iPadOS mobile operating systems, notifications may be delivered to the mobile devices 14 via Apple or Google notification services 182, as will be readily understood by those familiar with the use of such services. The mobile server 178 facilitates configuration of the notification services at the system level and/or at the user level.

With respect to configuration of the mobile information distribution, the mobile server 178 provides some configuration services via the mobile device interface, which is native to the mobile devices 14. The mobile server 178 also provides configuration options via web pages (i.e., using a web browser). As will be understood (e.g., in view of U.S. Patent Application Publication No. 2018/0109651, the entirety of which is hereby incorporated herein by reference), various alarm lists and watch lists may be configured via the web interface using searches (i.e., searching the indexed data of the configuration file 74) and/or filters, and taking advantage of the system hierarchy information, functional classifications, alarm priorities, alarm categories, and the like.

The availability of the configuration data at the mobile services level 158 may serve to provide a particularly rich mobile environment for the end user, because the system has access not just to the data, but to the relationships between the data. Moreover, in the presently described embodiments implementing secure authentication protocols, the process control system 10 may be controlled or otherwise interacted with, in addition to monitored. By way of example, instead of having only the status of an alarm (e.g., active) or the status of a parameter value (e.g., normal, high, low, etc.), the mobile server 178, by way of the configuration data from the configuration file 74, has access to the contextual relationships between the data and the data types. Thus, the system can determine that a particular active alarm is the result of a parameter status that is “high” and, in turn, that the parameter status is “high” because the parameter data value exceeds a particular limit. As a result of this rich contextual information available to the mobile server 178, the user interface is operable to present data in context—an alarm may be depicted with real-time data and history, for instance, or a process variable may be depicted with the current and historical set-point values and, optionally, relevant module relationships, which may allow the user to navigate from one data to other, related, data based on relationships between process control devices, function blocks, etc.

Further, in a securely authenticated environment, the mobile server 178 may receive data and/or commands from the mobile device(s) 14 and may pass commands and/or data back to the data services level 156 and/or the plant level 154, in contrast to prior art systems in which the transmission of data back to the plant level 154 was prohibited in order to ensure the security of the process plant environment 10. That is, the requirement that communications from the plant level 154 to the data services level 156 and/or the mobile services 158 be unidirectional may be relaxed because the mobile devices 14 from which such communications may be received are securely authenticated. As a result, a user of a mobile device 14 may cause alarm acknowledgements and control commands to be transmitted back to plant level 154, if the control plant 10 is configured to allow such communications.

### Authentication Services

The authentication services component 183 depicted in FIG. 2 comprises a sub-architecture with components 183A local to the process control plant 10 in the mobile services level 158, and components 1838 remote from the process control plant 10 and accessible via the Internet. The components 1838 include a graphical user interface (GUI) application (also referred to herein as a process control application) 200 executing on the mobile device(s) 14, and a variety of components that may be hosted on a cloud computing platform, such as the Microsoft Azure cloud computing platform, and referred to herein as “hosted components.” The hosted components, which will be described in greater detail below, include a Relay Hybrid Connection (RHC) (also referred to herein as a relay element) 202, a representative state transfer (REST) application programming interface (API) 204, a Relay Management API 206, a Relay Access API 208, a Relay Management Database 210, a key vault 212, and an application services web API 214.

The components 183A include a Relay Gateway Service (RGS) 218 communicatively coupled to the mobile server 178. The RGS 218 may be a software component executing on the mobile server 178.

The RHC 202 is responsible for facilitating secure communication via a secure communication channel between the mobile application 200 and the mobile server 178 using the Internet (including via wired, wireless, and/or cellular communications infrastructure). In particular, the RHC 202 may cooperate with the RGS 218 to pass data (including authentication data and process data) between the mobile application 200 and the mobile server 178. As will be described below, the RHC 202 creates the secure communication channel using a variety of authentication processes that ensure that the mobile server 178 and each user of the mobile application 200 are properly authenticated, to prevent unauthorized access to the process control system 10.

The REST API 204 is composed of multiple APIs that manage the RHC 202, and is responsible for generating and storing the keys that authenticate to the RHC 202 both the mobile applications 200 and the mobile server 178. Specifically, the REST API 204 generates and stores the send key that authenticates the mobile application 200 to the RHC 202, and the listen key that authenticates the mobile server 178 to the RHC 202.

The Relay Management API 206 is responsible for creating, enabling, and disabling the RHC 202 of various customer sites. That is, the Relay Management API 206 may be a global component operating on the cloud-computing platform that is not specific to the architecture of a particular process plant operator, but may instead create RHCs 202 for various different process plants. The Relay Management API 206 may cooperate with the REST API 204 to manage the RHC 202. The Relay Management API 206 is also responsible for providing the RHC information and communicating with the Relay Management Database 210 to store the RHC information.

The Relay Access API 208 is similarly hosted on the cloud-computing platform. The Relay Access API 208 facilitates the initial access by the mobile application 200 to the RHC 202 and the setup of the communication connection between the mobile application 200 and the mobile server 178. In particular, the Relay Access API 208 receives from the mobile application 200 a request for an authentication token (described later with respect to a “send key”), along with a user name and password of a person using the mobile application 200. The Relay Access API 208 facilitates the request to validate that the mobile application 200 is valid.

The Relay Management Database 210 is also hosted on the cloud computing platform. The Relay Management Database 210 is a common component that stores the RHC information (address, connection state, etc.) of the various customer sites using the secure off-premises architecture.

The key vault 212 stores various access tokens and authentication credentials. These may include credentials for authenticating the application services web API 214 to the relay management database 210, credentials for authenticating the application services web API 214 to the REST API 204, credentials for authenticating the relay access API 208 to the relay management API 206, credentials for authenticating the relay management API 206 to the REST API 204, etc.

The application services web API 214 is similarly hosted on the cloud-computing platform. The application services web API 214 facilitates back-end communication between the mobile server 178 and the rest of the components 1836 and, in particular, facilitates the setup of the RHC 202 and access by the mobile server 178 to the RHC 202. The application services web API 214 receives from the mobile server 178 a request for an authentication token (described later with respect to a “listen key”), along with providing the mobile server 178 access to change the operation of the RHC 202 by, for example, enabling the RHC 202, disabling the RHC 202, changing the address of the RHC 202, etc.

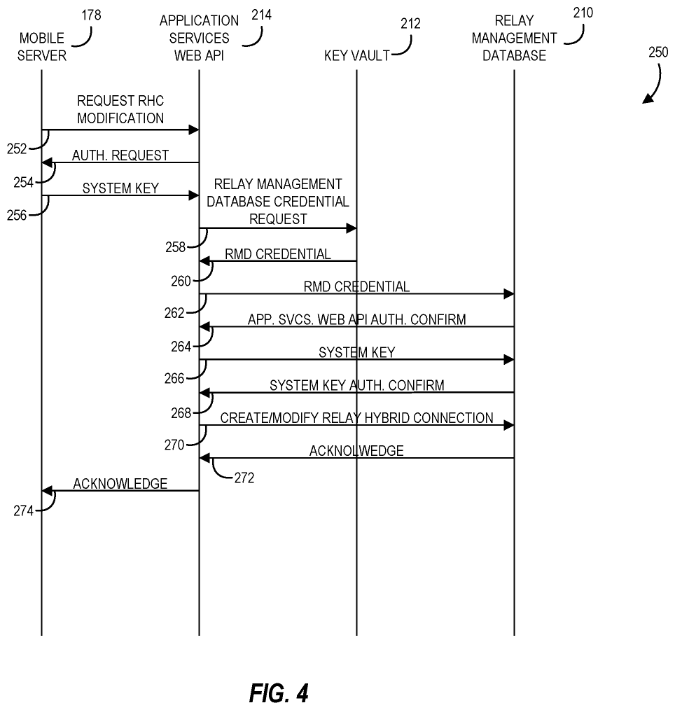

FIG. 4 is a communication flow diagram depicting communication between various elements in the system during a method 250 for authentication of the mobile server 178 and setup of the RHC 202. During operations to create, enable, disable, or otherwise modify the operation of the RHC 202, the mobile server 178 transmits to the application services web API 214 a modification of the RHC 202 (message 252). The application services web API 214 may respond to the mobile server 178 with a request to authenticate (message 254), in response to which, the mobile server 178 may transmit a system key 256 (message 256). In embodiments, the system key may be a license key, or a portion thereof, provided to the mobile server 178, or associated with a piece of software or a routine executing on the mobile server 178. It should be understood that the communication flows depicted in FIG. 4 and in other figures could be modified slightly such that some messages are combined. For example, the message 252 in which the mobile server 178 requests access to the application services web API 214 may also include the system key, such that the messages 254 and 256 are eliminated. These types of adjustments are well understood in the art and may result in additional efficiencies.

Upon receiving the system key, the application services web API 214 may request from the key vault 212 a credential that confers access by the application services web API 214 to the relay management database 210 (message 258). The key vault 212 may have already authenticated the application services web API 214 or, in embodiments, the key vault 212 authenticates the application services web API 214 using an active directory managed identity. For example, the managed identity may be enabled and created for the application services web API 214 upon its instantiation in the cloud-based platform, and the key vault 212 may rely on the managed identity to ensure that the application services web API 214 can securely access the key vault 212. In response to the request for the credential (message 258), the key vault 212 may transmit to the application services web API 214 the credential for accessing the relay management database 210 (message 260).

Having received from the key vault 212 the credential for accessing the relay management database 210 (message 260), the application services web API 214 may transmit the credential to the relay management database 210 (message 262) and, in response, may receive a message confirming successful authentication (message 264). The application services web API 214 may then transmit to the relay management database 210 the system key received from the mobile server 178 (message 266) and, in response, may receive from the relay management database 210 confirmation that the system key is authorized (message 268). The application services web API 214 may then transmit one or more request(s) for any actions related to the RHC 202, including creating the RHC 202 (which is already provisioned within in the relay management database 210), enabling the RHC 202, disabling the RHC 202, and/or modifying the operation of the RHC 202 (message 270). In response, the relay management database 210 may transmit to the application services web API 214 a message acknowledging the request and/or acknowledging successful completion of the requested modification (message 272). The application services web API 214 may forward an acknowledgement of the successful completion of the requested modification (message 274).

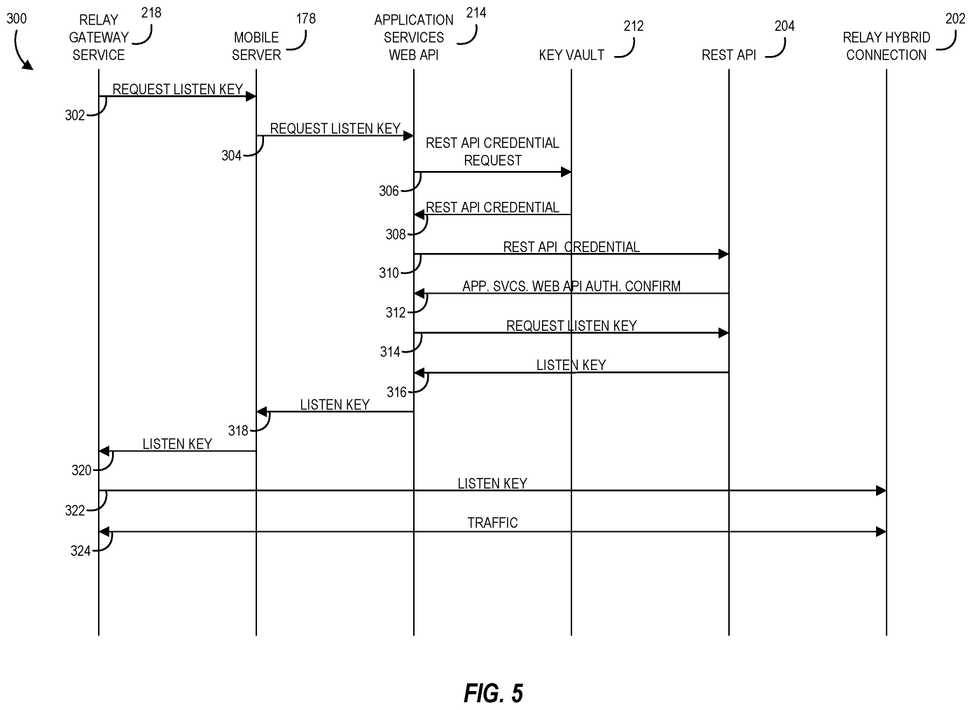

Once the RHC 202 is created and executing on the cloud-based platform, the mobile server 178 needs to be able to authenticate itself to the RHC 202. FIG. 5 is a communication flow diagram depicting communication between various elements in the system during a method 300 for authentication of the mobile server 178 to the RHC 202. In embodiments, this is initiated by a request from the relay gateway service 218 to the mobile server 178 for the listen key (message 302). As alluded to above, the listen key is an authentication credential that authenticates the mobile server 178 to the RHC 202 to ensure that the mobile server 178 is authorized to access the secure channel to the mobile applications 200. In response to this request, the mobile server 178 transmits to the application services web API 2141 a request for the listen key (message 304). The application services web API 214, in response to the request for the listen key (message 304) transmits to the key vault 212 a request for a credential to access the REST API 204 (message 306). As described above, the key vault 212 may have already authenticated the application services web API 214 or, in embodiments, the key vault 212 authenticates the application services web API 214 using an active directory managed identity. For example, the managed identity may be enabled and created for the application services web API 214 upon its instantiation in the cloud-based platform, and the key vault 212 may rely on the managed identity to ensure that the application services web API 214 can securely access the key vault 212. In response to the request for the credential (message 306), the key vault 212 may transmit to the application services web API 214 the credential for accessing the REST API 204 (message 308).

Having received the credential for accessing the REST API 204, the application services web API 214 may transmit the REST API credential to the REST API 204 (message 310), which may respond to the application services web API 214 with a message acknowledging successful authentication (message 312). The application services web API 214 may then transmit to the REST API 204 a request for the listen key (message 314), in response to which, the REST API 204 may transmit to the application services web API 214 the listen key (message 316). Of course, certain messages may be combined. For example, the application services web API 214 may request the listen key at the same time as it sends the REST API credential, and the REST API 214 may send the authentication acknowledgement at the same time as the listen key, for example. The application services web API 214 may transmit the listen key back to the mobile server 178 (message 318), which, in turn, may transmit the listen key to the relay gateway service 218 (message 320). The relay gateway service 218 may transmit the listen key to the RHC 202 (message 322). The RHC 202, when instantiated/created, is programmed with its listen key. Accordingly, when the RHC 202 receives the correct listen key from the mobile server 178 via the relay gateway service 218, the RHC 202 authenticates the mobile server, after which the mobile server 178 may communicate, via the relay gateway service 218 and the RHC 202 with the mobile applications 200 (messages 324).

The listen key, as well as any other data transmitted between the mobile application 200 and the relay gateway service 218 is generally transmitted using the HTTPS protocol, and may include a request header that contains an identity server authentication token, and a cloud platform token. The HTTP request and response body may include data in the JavaScript Object Notation (JSON) format.

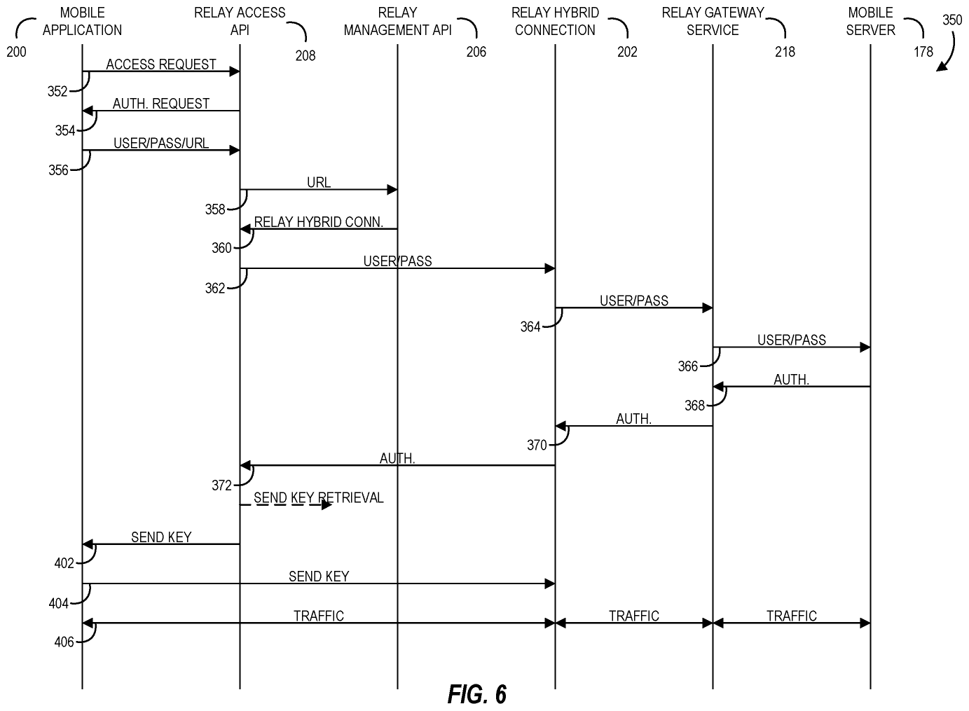

FIG. 6 is a communication flow diagram depicting communication between various elements in the system during a method 350 for authentication of the mobile application 200 to the RHC 202. In order to establish a connection to the RHC 202, the mobile application 202 sends an access request to the relay access API 208 (message 352). The relay access API 208 may request authentication information from the mobile application 200 (message 354), in response to which the mobile application 200 may send to the relay access API 208 a username and password associated with the user of the mobile application 200, and a URL for the RHC 202 (message 356). In an embodiment, the URL for the RHC 202 may take the form of https://{relay namespace}.{cloud computing platform namespace}/{hybrid connection name}. As an example, the URL referring to a particular RHC 202 may be https://Relay-65.servicebus.windows.net/HC100. The relay access API 208 may send to the relay management API 206 the URL received from the mobile application 200 (message 358) and, in response may receive from the relay management API 206 information for the RHC 202 (message 360).

Armed with the information for the RHC 202, the relay access API 208 may transmit to the RHC 202 the username and password information received from the mobile application 200 (message 362). The RHC 202 may transmit the username and password information to the relay gateway service 218 (message 364), which, in turn, may transmit the username and password information to the mobile server 178 (message 366). The mobile server 178 authenticates the username and password and transmits to the relay gateway service 218 an authentication message (message 368) confirming that the username and password are valid (if, in fact, that is true). The relay gateway service 218 forwards the message to the RHC 202 (message 370), which, in turn, forwards the message to the relay access API 208 (message 372).

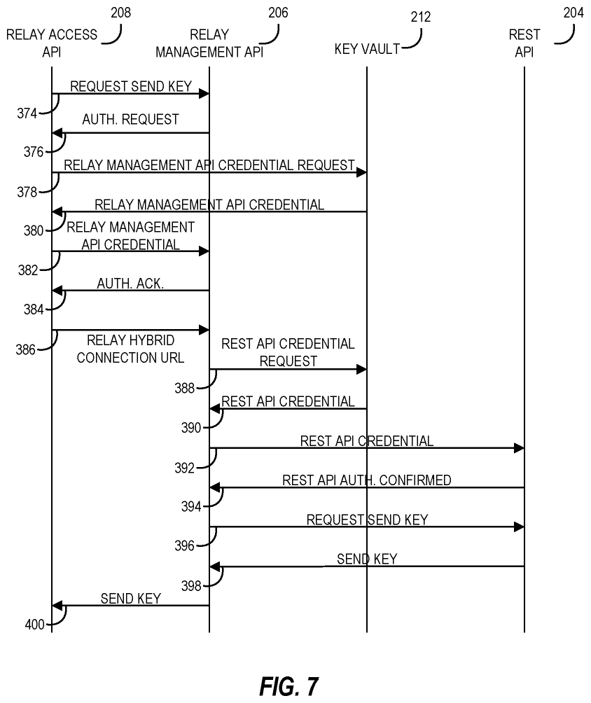

Having confirmed the identity of the user of the mobile application 200, the relay access API 208 can now request a send key for the mobile application 200. As described above, the send key is an authentication credential that proves to the RHC 202 that the application 200 is authorized to access the secure channel for communicating with the mobile server 178. With reference to FIG. 7, the relay access API 208 may transmit to the relay management API 206 a request for the send key (message 374). The relay management API 206 may request authentication information from the relay access API 208 (message 376). The relay access API 208 may transmit to the key vault 212 a request for a corresponding credential (message 378). The key vault 212 may have already authenticated the relay access API 208 or, in embodiments, the key vault 212 authenticates the relay access API 208 using an active directory managed identity. For example, the managed identity may be enabled and created for the relay access API 208 upon its instantiation in the cloud-based platform, and the key vault 212 may rely on the managed identity to ensure that the relay access API 208 can securely access the key vault 212. In response to the request for the credential (message 378), the key vault 212 may transmit to the relay access API 208 the requested credential (message 380).

Having received the requested credential, the relay access API 208 may transmit the credential to the relay management API 206 (message 382), which may acknowledge the authentication (message 384). The relay access API 208 may then send to the relay management API 206 a URL for the RHC 202 for which it is requesting a send key (message 386).

In order to authenticate with the REST API 204, the relay management API 206 may transmit to the key vault 212 a request for a credential for authenticating the relay management API 206 to the REST API 204 (message 388). The key vault 212 may have already authenticated the relay management API 206 or, in embodiments, the key vault 212 authenticates the relay management API 206 using an active directory managed identity. For example, the managed identity may be enabled and created for the relay management API 206 upon its instantiation in the cloud-based platform, and the key vault 212 may rely on the managed identity to ensure that the relay management API 206 can securely access the key vault 212. In response to the request for the credential (message 388), the key vault 212 may transmit to the relay management API 206 the requested credential (message 390).

With the requested credential in its possession, the relay management API 206 may transmit the credential to the REST API 204 (message 392) and, in response, may receive from the REST API 204 an authentication acknowledgement message (message 394). Having received acknowledgement of authentication, the relay management API 206 may transmit to the REST API 204 a request for the send key (message 396), in response to which the REST API 204 may transmit to the relay management API 206 the requested send key (message 398). The relay management API 206 may then forward the send key to the relay access API 208 (message 400).

With reference again to FIG. 6, having received the send key (message 400), the relay access API 208 may transmit the send key to the mobile application 200 (message 402). Thereafter, the mobile application 200 may transmit the send key to the RHC 202 (message 404). The RHC 202, when instantiated/created in the cloud-based platform, is programmed with its corresponding send key and, when the send key received from the mobile application 200 matches the send key programmed into the RHC 202, the RHC 202 may authenticate the mobile application 200 and, thereafter, allow communication between the mobile application 200 and the mobile server 178 via the RHC 202 and the relay gateway service 218 (messages 406).

The send key, as well as any other data transmitted from the mobile application 200 to the RHC 202 is generally transmitted using the HTTPS protocol, and may include a request header that contains an identity server authentication token, and a cloud platform token. The HTTP request and response body may include data in the JavaScript Object Notation (JSON) format.

The particular user associated with the mobile application 200 may result in specific messages being allowed or disallowed, acknowledged or ignored, by the mobile server 178. In embodiments, the RHC 202 may provide information about the user (e.g., by associating the send key with the user) to the mobile server 178. For example, the mobile server 178 may associate the mobile application 178 with the specific user and, as a result, may enable or disable user-specific actions such as: sending to the application 200 data associated with the user (i.e., data streams that the user has previously requested and/or has configured the mobile server 178 to transmit to the user via the mobile application 202), receiving process control commands from the user, logging commands received as received from the user, limiting the data sent and/or the commands implemented in response to the particular user, etc.

As should be understood in view of the present description, a single instance of the relay element 202 may facilitate communication between a mobile server 178 and a plurality or multiplicity of mobile process control applications 200. In embodiments, a single instance of a relay element 202 may provide communication between one or more mobile servers 178 serving an entire process control facility and any number of instances of the mobile process control application 200 corresponding to the personnel associated with maintaining and/or monitoring the process control facility. In other embodiments, a single instance of a relay element 202 may provide communication between one or more mobile servers 178 serving a portion of a process control facility and any number of instances of the mobile process control application 200 corresponding to the personnel associated with maintaining and/or monitoring the process control facility. Thus, the relay element 202 may authenticate more than one mobile process control application 200 and/or may authenticate more than one mobile server 318 in various embodiments.

What is claimed:

1. A cloud-based authentication method, the method comprising:
instantiating in a cloud-based server a relay element configured to transfer data between a process control application executing on a mobile device and a mobile server communicatively coupled to a process control environment;
receiving at the relay element, from the process control application executing on the mobile device, a first validation key;
comparing, in the relay element, the first validation key to an application validation key and (i) authenticating the process control application executing on the mobile device if the first validation key matches the application validation key and (ii) denying authentication to the process control application executing on the mobile device if the first validation key does not match the application validation key;
receiving at the relay element, from the mobile server, a second validation key;
authenticating the mobile server at the relay element if the second validation key is valid; and
allowing communication, via the relay element, between the process control application executing on the mobile device and the mobile server if both the process control application and the mobile server are validated.

2. A method according to claim 1, further comprising: receiving the application validation key from a relay access API.

3. A method according to claim 1, further comprising:
receiving at a relay access API a username and password associated with a user of the process control application executing on the mobile device;
receiving at the relay access API a URL associated with the relay element;
authenticating at the relay access API the user according to the username and password; and
providing to the process control application executing on the mobile device the first validation key if the user is authenticated.

4. A method according to claim 3, wherein authenticating the user according to the username and password comprises:
sending the username and password to the mobile server via a relay gateway service; and
receiving from the mobile server, via the relay gateway service, an indication that the user is authenticated.

5. A method according to claim 1, wherein allowing communication, via the relay element, between the process control application executing on the mobile device and the mobile server comprises:
receiving from the process control application executing on the mobile device one or more process control commands; and
forwarding the one or more process control commands to the mobile server via a relay gateway service.

6. A method according to claim 1, wherein allowing communication, via the relay element, between the process control application executing on the mobile device and the mobile server comprises:
receiving from the mobile server, via a relay gateway service, process data from the process control environment; and
forwarding the process data to the process control application executing on the mobile device.

7. A method of authenticating a process control application executing on a mobile device, the method comprising:
transmitting, from the process control application to a relay access API, a username and password of a user of the process control application;
transmitting, from the process control application to a relay access API, a URL associated with a cloud-based relay element;
receiving, at the process control application from the relay access API, in response to the username and password, a first validation key;
transmitting, from the process control application to the cloud-based relay element, the first validation key;
receiving, at the process control application, an indication from the relay element that the user is authenticated; and
transmitting, from the process control application to the relay element, one or both of (i) a request to receive from a mobile server process control data from a process control environment and (ii) a process control command to effect a control action in the process control environment.

8. A method according to claim 7, further comprising:
receiving at the process control application, from the mobile server, via the cloud-based relay element, real-time process control data.

9. A method according to claim 7, wherein transmitting the request to receive from the mobile server the process control data comprises:
receiving at the process control application, from the mobile server, via the cloud-based relay element, a list of process control variables available to be received;
receiving at the process control application, a selection by the user of one or more of the process control variables;
transmitting from the process control application to the mobile server, via the cloud-based relay element, the selection of the one or more process control variables; and
receiving the one or more process control variables at the process control application.

10. A method of providing process control data to a process control application operating on a mobile device, the method comprising:
sending, from a mobile server communicatively coupled to a process control environment, to an application web services API operating on a cloud-based server, a command to instantiate in the cloud-based server a relay element configured to transfer data between the process control application and the mobile server;
sending to the relay element, via a relay gateway service, a validation key operable to authenticate the mobile server to the relay element;
receiving from the process control application, via the relay element and the relay gateway service, a username and a password associated with a user of the process control application;
authenticating the user of the process control application;
sending to the process control application, via the relay element and the relay gateway service, a list of available process control data;
receiving from the process control application, via the relay element and the relay gateway service, a selection of process control data to transmit; and
transmitting to the process control application, via the relay element and the relay gateway service, the selected process control data.

11. The method according to claim 10, wherein the available process control data include every datum available to an operator within the process plant.

12. The method according to claim 10, further comprising:
receiving from the process control application, via the relay element and the relay gateway service, a process control command to effect a control action in the process control environment;
transmitting to a controller in the process control environment the process control command.

13. A system for providing to a process control application secure off-premises access to a process control environment, the system comprising:
a mobile server communicatively coupled to a process control environment and configured to (i) receive from the process control environment real-time process control data, and (ii) send control commands to a controller in the process control environment;
a cloud-based server environment, communicatively coupled to the mobile server, via a relay gateway service, the cloud-based server environment comprising:
a cloud-based relay element configured to transfer data between the process control application executing on a mobile device and the mobile server;
a first application programming interface (API) configured to receive from the mobile server a request to instantiate and enable the cloud-based relay element; and
a second API configured to receive from the process control application a request to access the cloud-based relay element, to authenticate a user of the process control application, and to provide to the process control application a first validation key for accessing the cloud-based relay element;
a relay management database storing configuration information for the cloud-based relay element; and
a key vault element storing authentication keys;
a first network coupling the mobile server to the process control environment;
a second network coupling the mobile server to the cloud-based server environment; and
a third network coupling the process control application to the cloud-based server environment.

14. A system according to claim 13, wherein the second network and the third network each comprise the Internet.

15. A system according to claim 13, wherein the third network comprises a cellular telephony data network.

16. A system according to claim 13, further comprising a third API configured to:
receive from the second API a request for the first validation key;
transmit to a fourth API a request for the first validation key;
receive from the fourth API the first validation key; and
transmit the first validation key to the second API to provide to the process control application.

17. A system according to claim 13, wherein the cloud-based relay element is programmed with the first validation key.

18. A system according to claim 16, wherein the third API is further configured to:
request from the key vault a key for authenticating the third API to the fourth API;
receive from the key vault the key for authenticating the third API to the fourth API;
transmit to the fourth API the key for authenticating the third API to the fourth API;
transmit to the fourth API a request for the first validation key; and
receive from the fourth API the first validation key.

19. A system according to claim 13, further comprising authenticating the mobile server to the cloud-based relay element, the authentication of the mobile server to the cloud-based relay element comprising:
transmitting from the first API to the key vault a request a key for authenticating the first API to the relay management database;
receiving at the first API from the key vault the key for authenticating the first API to the relay management database;
transmitting from the first API to the relay management database the key for authenticating the first API to the relay management database;
receiving at the first API from the relay management database a second validation key for authenticating the mobile server to the cloud-based relay element;
transmitting from the first API to the mobile server the second validation key; and
transmitting from the mobile server to the cloud-based relay element, via a relay gateway service, the second validation key.
